(19) United States
(12) Patent Application Publication
(10) Pub. No.: US 2013/0255314 A1
(43) Pub. Date: Oct. 3, 2013

(54) METHOD FOR FUSION DRAWING ION-EXCHANGEABLE GLASS

(71) Applicants: Douglas C. Allan, Corning, NY (US); Bradley F. Bowden, Corning, NY (US); Xiaoju Guo, Painted Post, NY (US); John C. Mauro, Corning, NY (US); Marcel Potuzak, Corning, NY (US)

(72) Inventors: Douglas C. Allan, Corning, NY (US); Bradley F. Bowden, Corning, NY (US); Xiaoju Guo, Painted Post, NY (US); John C. Mauro, Corning, NY (US); Marcel Potuzak, Corning, NY (US)

(21) Appl. No.: 13/431,374

(22) Filed: Mar. 27, 2012

(51) Int. Cl. C03B 17/06; C03C 21/00; C03B 15/02

(52) U.S. Cl. 65/30.14; 65/90; 65/53; 65/85

(57) ABSTRACT

A method of making glass through a glass ribbon forming process in which a glass ribbon is drawn from a root point to an exit point is provided. The method comprises the steps of: (I) cooling the glass ribbon at a first cooling rate from an initial temperature to a process start temperature, the initial temperature corresponding to a temperature at the root point; (II) cooling the glass ribbon at a second cooling rate from the process start temperature to a process end temperature; and (III) cooling the glass ribbon at a third cooling rate from the process end temperature to an exit temperature, the exit temperature corresponding to a temperature at the exit point, wherein an average of the second cooling rate is lower than an average of the first cooling rate and an average of the third cooling rate.

### TECHNICAL FIELD

The present disclosure relates to methods of making glass and, more particularly, methods of making glass with high compressive stresses such as an ion-exchanged glass.

### BACKGROUND

Glass used in the screen of some types of display devices should have a certain level of damage resistance because the glass may be exposed to impact as a result of the device being transported, shaken, dropped, struck or the like. For example, scratch resistance of the glass is one quality of glass that is valuable in portable display devices so that a user is provided with a clear view of an image on the display.

The compressive stress achievable after ion exchange can be influenced by the thermal history of the glass. Consequently, for fusion drawn glass, proper control of the thermal history during the fusion process can enhance the potential compressive stress during subsequent ion exchange.

### SUMMARY

In one example aspect, a method of making glass through a glass ribbon forming process in which a glass ribbon is drawn from a root point to an exit point is provided. The method comprising the steps of: (I) decreasing a temperature of the glass ribbon from an initial temperature to a process start temperature, the initial temperature corresponding to a temperature at the root point; (II) decreasing a temperature of the glass ribbon from the process start temperature to a process end temperature; and (III) decreasing a temperature of the glass ribbon from the process end temperature to an exit temperature, the exit temperature corresponding to a temperature at the exit point. A fictive temperature of the glass ribbon lags an actual temperature of the glass ribbon in step (II), and a duration of step (II) is substantially longer than a duration of step (I) and a duration of step (III).

In another example aspect, a method of making glass through a glass ribbon forming process in which a glass ribbon is drawn from a root point to an exit point is provided. The method comprises the steps of: (I) cooling the glass ribbon at a first cooling rate from an initial temperature to a process start temperature, the initial temperature corresponding to a temperature at the root point; (II) cooling the glass ribbon at a second cooling rate from the process start temperature to a process end temperature; and (III) cooling the glass ribbon at a third cooling rate from the process end temperature to an exit temperature, the exit temperature corresponding to a temperature at the exit point, wherein an average of the second cooling rate is lower than an average of the first cooling rate and an average of the third cooling rate.

### BRIEF DESCRIPTION OF THE DRAWINGS

These and other aspects are better understood when the following detailed description is read with reference to the accompanying drawings, in which:

FIG. 1 is an example method and apparatus for making glass;

FIG. 2 is a graph showing by bath temperature the compressive stress at a given depth from a surface of the glass versus the fictive temperature for an example type of glass;

FIG. 3 is a graph showing the temperature of a glass ribbon versus the distance from a root point in the example method for a conventional method of cooling (dotted line) and for a cooling method including a slowed cooling stage (solid line);

FIG. 4 is a graph showing final fictive temperatures obtained where a glass ribbon is cooled within various viscosity ranges over a first process duration;

FIG. 5 is a graph showing final fictive temperatures obtained where a glass ribbon is cooled within various viscosity ranges over a second process duration;

FIG. 6 is a graph showing final fictive temperatures obtained where a glass ribbon is cooled within various viscosity ranges over a third duration;

FIG. 7 is a graph showing the logarithm of the final viscosity of the glass ribbon versus the logarithm of an exit time of the glass ribbon;

FIG. 8 is a graph showing the logarithm of a process viscosity range of the glass ribbon versus the logarithm of the difference between the exit time and the process start time;

FIG. 9 is a schematic illustration of heating elements and insulating walls that extend from the root point to an exit point of the glass ribbon.

### DETAILED DESCRIPTION

Examples will now be described more fully hereinafter with reference to the accompanying drawings in which example embodiments are shown. Whenever possible, the same reference numerals are used throughout the drawings to refer to the same or like parts. However, aspects may be embodied in many different forms and should not be construed as limited to the embodiments set forth herein.

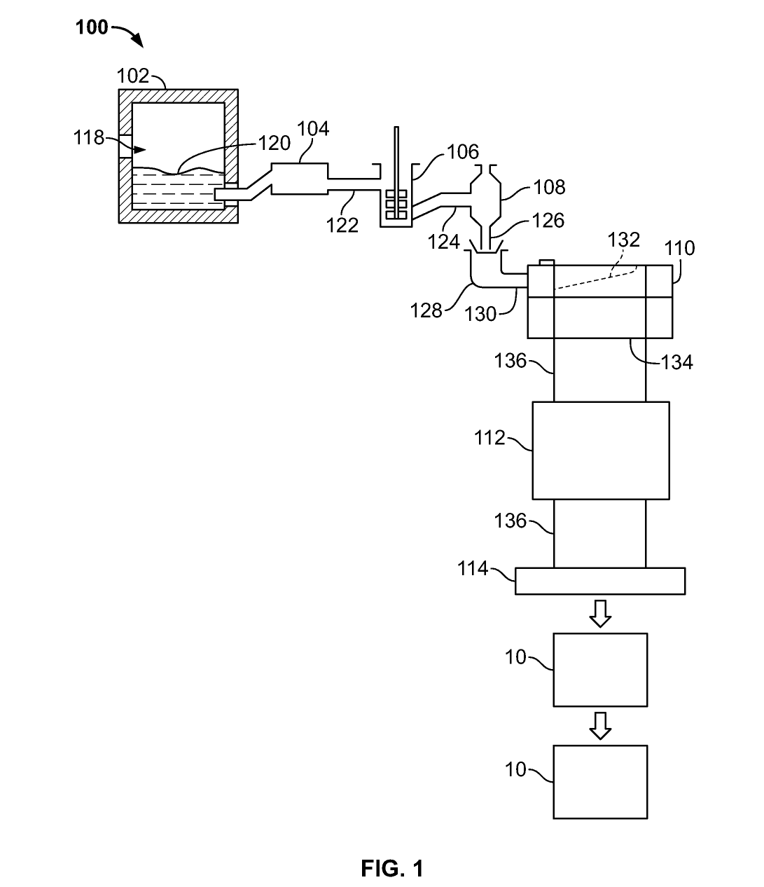

FIG. 1 shows an example embodiment of a glass manufacturing system 100 or, more specifically, a fusion draw machine that implements the fusion process as just one example for manufacturing a glass sheet 10. The glass manufacturing system 100 may include a melting vessel 102, a fining vessel 104, a mixing vessel 106, a delivery vessel 108, a forming vessel 110, a pull roll assembly 112 and a scoring apparatus 114.

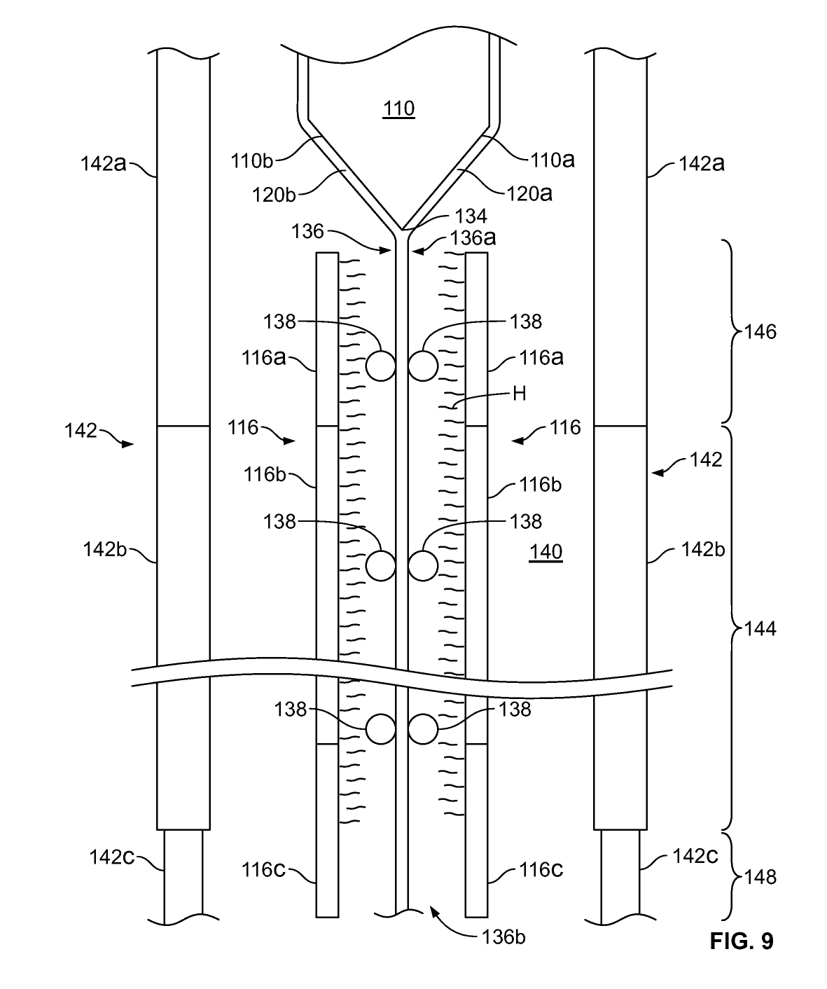

The melting vessel 102 is where the glass batch materials are introduced as shown by arrow 118 and melted to form molten glass 120. The fining vessel 104 has a high temperature processing area that receives the molten glass 120 from the melting vessel 102 and in which bubbles are removed from the molten glass 120. The fining vessel 104 is connected to the mixing vessel 106 by a finer to stir chamber connecting tube 122. Thereafter, the mixing vessel 106 is connected to the delivery vessel 108 by a mixing vessel to delivery vessel connecting tube 124. The delivery vessel 108 delivers the molten glass 120 through a downcomer 126 to an inlet 128 and into the forming vessel 110. The forming vessel 110 includes an opening 130 that receives the molten glass 120 which flows into a trough 132 and then overflows and runs down two converging sides of the forming vessel 110 before fusing together at what is known as a root 134. The root 134 is where the two converging sides (e.g., see 110a, 110b in FIG. 9) come together and where the two flows (e.g., see 120a, 120b in FIG. 9) of molten glass 120 rejoin before being drawn downward by the pull roll assembly 112 to form the glass ribbon 136. Then, the scoring apparatus 114 scores the drawn glass ribbon 136 which is then separated into individual glass sheets 10.

An ion exchange process may be performed on the individual glass sheets 10 in order to improve the scratch resistance of the individual glass sheets 10 and to form a protective layer of potassium ions under high compressive stress near a surface of the glass sheets 10. The compressive stress at a given depth from the surface of the glass may depend on, among other factors, glass composition, ion exchange temperature, duration of ion exchange, and the thermal history of the glass.

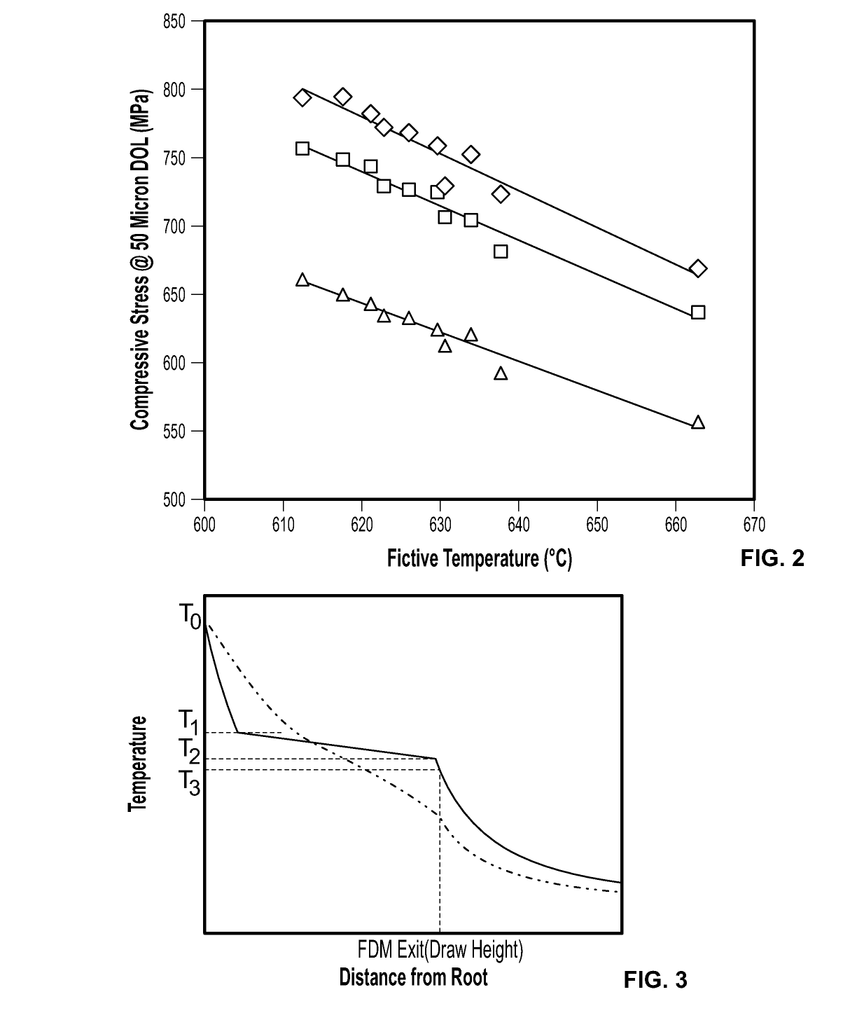

One indicator of the thermal history of the glass is the fictive temperature of the glass and, as shown in FIG. 2, glass with a lower fictive temperature tends to have higher compressive stresses at a given depth of layer (e.g., 50 microns). FIG. 2 is a plot of compressive stress (measured in megapascals at 50 microns depth of layer) as a function of fictive temperature (measured in degrees Celsius) for three different bath temperatures. The diamonds denote points corresponding to a bath temperature of 450° C., the squares denote points corresponding to a bath temperature of 470° C., and the triangles denote points corresponding to a bath temperature of 485° C. A linear fit is obtained for each set of points. As illustrated by FIG. 2, enhancement of the compressive stress CS at a fixed depth of a layer is linearly related with fictive temperature T_{f} and can be expressed by the equation, |ΔCS|=A*(−ΔT_{f}). Thus, the compressive stresses can be increased by lowering the fictive temperature of the glass.

The fictive temperature is a term used to describe systems that are cooled at such a fast rate as to be out of thermal equilibrium. A higher fictive temperature indicates a more rapidly cooled glass sample that is further out of thermal equilibrium. After the glass sample is first formed, a process known as aging occurs in which properties tend slowly towards their equilibrium values. The fictive temperature of a system differs from the actual temperature but relaxes toward it as the system ages. At high glass temperatures, the fictive temperature equals the ordinary glass temperature because the glass is able to equilibrate very quickly with its actual temperature. As the temperature is reduced, the glass viscosity rises exponentially with falling temperature while the speed of equilibration is dramatically reduced. As the temperature is reduced, the glass “falls out of equilibrium” because of its inability to maintain equilibrium as the temperature changes. As a result, the fictive temperature lags the actual temperature of the glass ribbon and, ultimately, the fictive temperature stalls at some higher temperature at which the glass no longer could equilibrate quickly enough to keep up with its cooling rate. The final fictive temperature will depend on how quickly the glass was cooled and will typically be in the range of approximately 600° C. to approximately 800° C. for LCD substrate glass at room temperature. Therefore, in order to reach a low final fictive temperature, the cooling rate can be reduced while the glass is being formed.

When a glass is formed using a cooling rate of 10K/min, the fictive temperature of glass corresponds to roughly the 10¹³ poise isokom temperature. According to equation (8) in ref. [Y. Yue, R. Ohe, and S. L. Jensen, J. Chem. Phys. V120, (2004)], the fictive temperature of glass can be related to the logarithm of cooling rate through the equation:

$$\frac{d log {Q}_{c}}{d log η} = - 1 \qquad ( 1 )$$

where Q_{c} is the cooling rate and η is the equilibrium viscosity of the liquid state. The relationship between equilibrium viscosity and temperature is fairly linear where log(η/poise)=10˜13. Thus, the differential formula shown in Eq. (1) can be rewritten as,

$$\frac{d ( log {Q}_{c} )}{d log η} = - 1 , \qquad ( 2 )$$

for the viscosity region from log(η/poise)=11 to the strain point of the glass. According to Angell's definition of fragility,

$$m = \frac{d log η}{d \frac{{T}_{g}}{T}} = \frac{Δ log η}{Δ ( \frac{{T}_{g}}{T} )} \qquad ( 3 )$$

where m is the fragility, and T_{g} is the glass transition temperature and is the 10¹³ poise isokom temperature. From Eq. (3), we can derive a new expression for Δ log η, and when substituting this expression into Eq. (2) obtain

$$Δ log {Q}_{c} = - m Δ \frac{{T}_{g}}{T} . \qquad ( 4 )$$

If we take T_{g} equal to 10 K/min cooling as a reference, the fictive temperature corresponding to fusion cooling can be calculated as,

$$log {Q}_{c} - log ( 10 ) = - m ( \frac{{T}_{g}}{{T}_{f }} - \frac{{T}_{g}}{{T}_{g}} ) , \\ log {Q}_{c} - 1 = - m ( \frac{{T}_{g}}{{T}_{f}} - 1 ) , \\ {T}_{f} = \frac{{T}_{g}}{1 - \frac{log {Q}_{c} - 1}{m}} . \qquad ( 5 )$$

The glass transition temperatures can be selected as 800 K and 1000 K and the fragility can be selected as 26 and 32. From Eq. (5), for a specific cooling rate like 600 K/min, the fictive temperature will be about 50 to 70° C. higher than T_{g} whereas T_{g} is approximately the fictive temperature of glass formed at a cooling rate of 10 K/min.

While the fictive temperature shown above is a good estimate for linear cooling, a cooling rate might not be linear in a glass making process such as a fusion draw method. In such cases, the following example procedure can be used to calculate the fictive temperature associated with the thermal history and glass properties of a particular glass composition.

In an example embodiment, the methods and apparatus for predicting/estimating the fictive temperature discussed herein have as their base an equation of the form:

log₁₀η(T,T_{f},x)=y(T,T_{f},x)log₁₀η_{eq}(T_{f},x)+[1−y(T,T_{f},x)]log₁₀ηₙₑ(T,T_{f},x) (6)

In this equation, η is the glass's non-equilibrium viscosity which is a function of composition through the variable “x”, η_{eg} (T_{f},x) is a component of η attributable to the equilibrium liquid viscosity of the glass evaluated at fictive temperature T_{f} for composition x (hereinafter referred to as the “first term of Eq. (6)”), ηₙₑ (T,T_{f},x) is a component of η attributable to the non-equilibrium glassy-state viscosity of the glass at temperature T, fictive temperature T_{f}, and composition x (hereinafter referred to as the “second term of Eq. (6)”), and y is an ergodicity parameter which satisfies the relationship: 0≦y(T,T_{f},x)<1.

In an embodiment, y(T,T_{f},x) is of the form:

$$y ( T , {T}_{f} , x ) = {[ \frac{min ( T , {T}_{f} )}{max ( T , {T}_{f} )} ]}^{p ( {x}_{ref} ) m ( x ) / m ( {x}_{ref} )} \qquad ( 7 )$$

(For convenience, the product p(x_{ref})m(x)/m(x_{ref}) will be referred to herein as “p(x)”.)

This formulation for y(T,T_{f},x) has the advantage that through parameter values p(x_{ref}) and m(x_{ref}), Eq. (7) allows all the needed parameters to be determined for a reference glass composition x_{ref} and then extrapolated to new target compositions x. The parameter p controls the width of the transition between equilibrium and non-equilibrium behavior in Eq. (6), i.e., when the value of y(T,T_{f},x) calculated from Eq. (7) is used in Eq. (6). p(x_{ref}) is the value of p determined for the reference glass by fitting to experimentally measured data that relates to relaxation, e.g., by fitting to beam bending data and/or compaction data. The parameter m relates to the “fragility” of the glass, with m(x) being for composition x and m(x_{ref}) being for the reference glass. The parameter m is discussed further below.

In an embodiment, the first term of Eq. (1) is of the form:

$${log}_{10} {η}_{eq} ( {T}_{f} , x ) = {log}_{10} {η}_{∞} + ( 12 - {log}_{10} {η}_{∞} ) \frac{{T}_{g} ( x )}{{T}_{f}} \cdot exp [ ( \frac{m ( x )}{12 - {log}_{10} {η}_{∞}} - 1 ) ( \frac{{T}_{g} ( x )}{{T}_{f}} - 1 ) ] \qquad ( 8 )$$

In this equation, η_{∞}=10^{-2.9} Pa·s is the infinite-temperature limit of liquid viscosity, a universal constant, T_{g}(x) is the glass transition temperature for composition x, and, as discussed above, m(x) is the fragility for composition x, defined by:

$${m ( x ) = \frac{\partial {log}_{10} {η}_{eq} ( T , x )}{\partial ( {T}_{g} ( x ) / T )} \vert}_{T = {T}_{g} ( x )} \qquad ( 9 )$$

Both the glass transition temperature for composition x and the composition's fragility can be expressed as expansions which employ empirically-determined fitting coefficients.

The glass transition temperature expansion can be derived from constraint theory, which makes the expansion inherently nonlinear in nature. The fragility expansion can be written in terms of a superposition of contributions to heat capacity curves, a physically realistic scenario. The net result of the choice of these expansions is that Eq. (8) can accurately cover a wide range of temperatures (i.e., a wide range of viscosities) and a wide range of compositions.

As a specific example of a constraint theory expansion of glass transition temperature, the composition dependence of T_{g} can, for example, be given by an equation of the form:

$${T}_{g} ( x ) = \frac{{K}_{ref}}{d - {\sum }_{i} {x}_{i} {n}_{i} / {\sum }_{i} {x}_{j} {N}_{j} } , \qquad ( 10 )$$

where the nᵢ's are fitting coefficients, d is the dimensionality of space (normally, d=3), the Nⱼ's are the numbers of atoms in the viscosity-affecting components of the glass (e.g., N=3 for SiO₂, N=5 for Al₂O₃, and N=2 for CaO), and K_{ref} is a scaling parameter for the reference material x_{ref}, the scaling parameter being given by:

$${K}_{ref} = {T}_{g} ( {x}_{ref} ) ( d - \frac{{\sum }_{i} {x}_{ref , i} {n}_{i}}{{\sum }_{j} {x}_{ref , j} {N}_{j}} ) , \qquad ( 11 )$$

where T_{g}(x_{ref}) is a glass transition temperature for the reference material obtained from at least one viscosity measurement for that material.

The summations in Eqs. (10) and (11) are over each viscosity-affecting component i and j of the material, the xᵢ's can, for example, be expressed as mole fractions, and the nᵢ's can, for example, be interpreted as the number of rigid constraints contributed by the various viscosity-affecting components. In Eqs. (10) and (11), the specific values of the nᵢ's are left as empirical fitting parameters (fitting coefficients). Hence, in the calculation of T_{g}(x) there is one fitting parameter for each viscosity-affecting component i.

As a specific example of a fragility expansion based on a superposition of heat capacity curves, the composition dependence of m can, for example, be given by an equation of the form:

$$m ( x ) / {m}_{0} = ( 1 + {\sum }_{i} {x}_{i} \frac{Δ {C}_{p , i}}{Δ {S}_{i}} ) , \qquad ( 12 )$$

where m₀=12−log₁₀η_{∞}, the ΔC_{p,i}'s are changes in heat capacity at the glass transition, and the ΔSᵢ's are entropy losses due to ergodic breakdown at the glass transition. The constant m₀ can be interpreted as the fragility of a strong liquid (a universal constant) and is approximately equal to 14.9.

The values of ΔC_{p,i}/ΔSᵢ in Eq. (12) are empirical fitting parameters (fitting coefficients) for each viscosity-affecting component i. Hence, the complete equilibrium viscosity model of Eq. (8) can involve only two fitting parameters per viscosity-affecting component, i.e., nᵢ and ΔC_{p,i}/ΔSᵢ. Techniques for determining values for these fitting parameters are discussed in the above-referenced co-pending U.S. application incorporated herein by reference.

Briefly, in one embodiment, the fitting coefficients can be determined as follows. First, a set of reference glasses is chosen which spans at least part of a compositional space of interest, and equilibrium viscosity values are measured at a set of temperature points. An initial set of fitting coefficients is chosen and those coefficients are used in, for example, an equilibrium viscosity equation of the form of Eq. (8) to calculate viscosities for all the temperatures and compositions tested. An error is calculated by using, for example, the sum of squares of the deviations of log(viscosity) between calculated and measured values for all the test temperatures and all the reference compositions. The fitting coefficients are then iteratively adjusted in a direction that reduces the calculated error using one or more numerical computer algorithms known in the art, such as the Levenburg-Marquardt algorithm, until the error is adequately small or cannot be further improved. If desired, the process can include checks to see if the error has become “stuck” in a local minimum and, if so, a new initial choice of fitting coefficients can be made and the process repeated to see if a better solution (better set of fitting coefficients) is obtained.

When a fitting coefficient approach is used to calculate T_{g}(x) and m(x), the first term of Eq. (6) can be written more generally as:

log₁₀η_{eq}(T_{f},x)=C₁+C₂·(f₁(x,FC1)/T_{f})·exp([f₂(x,FC2)−1]·[f₁(x,FC1)/T_{f}−1])

where:
(i) C₁ and C₂ are constants,
(ii) FC1={FC¹₁, FC¹₂ . . . FC¹ᵢ . . . FC¹_{N}} is a first set of empirical, temperature-independent fitting coefficients, and
(iii) FC2={FC²₁,FC²₂ . . . FC²ᵢ . . . FC²_{N}} is a second set of empirical, temperature-independent fitting coefficients.

Returning to Eq. (6), in an embodiment, the second term of Eq. (6) is of the form:

$${log}_{10} {η}_{ne} ( T , {T}_{f} , x ) = A ( {x}_{ref} ) + \frac{Δ H ( {x}_{ref} )}{kT ln 10} - \frac{{S}_{∞} ( x )}{k ln 10} exp [ - \frac{{T}_{g} ( x )}{{T}_{f}} ( \frac{m ( x )}{12 - {log}_{10} {η}_{∞}} - 1 ) ] \qquad ( 13 )$$

As can be seen, like Eq. (8), this equation depends on T_{g}(x) and m(x), and those values can be determined in the same manner as discussed above in connection with Eq. (8). A and ΔH could in principle be composition dependent, but in practice, it has been found that they can be treated as constants over any particular range of compositions of interest. Hence the full composition dependence of ηₙₑ(T,T_{f},x) is contained in the last term of the above equation. The infinite temperature configurational entropy component of that last term, i.e., S_{∞}(x), varies exponentially with fragility. Specifically, it can be written as:

$${S}_{∞} ( x ) = {S}_{∞} ( {x}_{ref} ) exp ( \frac{m ( x ) - m ( {x}_{ref} )}{12 - {log}_{10} {η}_{∞}} ) \qquad ( 14 )$$

As with p(x_{ref}) discussed above, the value of S_{∞}(x_{ref}) for the reference glass can be obtained by fitting to experimentally measured data that relates to relaxation, e.g., by fitting to beam bending data and/or compaction data.

When a fitting coefficient approach is used to calculate T_{g}(x) and m(x), the second term of Eq. (6) can be written more generally as:

log₁₀ηₙₑ(T,T_{f},x)=C₃+C₄/T−C₅·exp(f₂(x,FC2)−C₆)·exp([f₂(x,FC2)−1]·[f₁(x,FC1)]T_{f}])

where:
(i) C₃, C₄, C₅, and C₆ are constants,
(ii) FC1={FC¹₁, FC¹₂ . . . FC¹ᵢ . . . FC¹_{N}} is a first set of empirical, temperature-independent fitting coefficients, and
(iii) FC2={FC²₁, FC²₂ . . . FC²ᵢ . . . FC²_{N}} is a second set of empirical, temperature-independent fitting coefficients.

When a fitting coefficient approach is used to calculate T_{g}(x) and m(x) for both the first and second terms of Eq. (6), those terms can be written more generally as:

log₁₀η_{eq}(T_{f},x)=C₁+C₂·(f₁(x,FC1)/T_{f})·exp([f₂(x,FC2)−1]·[f₁(x,FC1)/T_{f}−1]),

and

log₁₀ηₙₑ(T,T_{f},x)=C₃+C₄/T−C₅·exp(f₂(x,FC2)−C₆)·exp([f₂(x,FC2)−1]·[f₁(x,FC1)/T_{f}]),

where:
(i) C₁, C₂, C₃, C₄, C₅, and C₆ are constants,
(ii) FC1={FC¹₁,FC¹₂ . . . FC¹ᵢ . . . FC¹_{N}} is a first set of empirical, temperature-independent fitting coefficients, and
(iii) FC2={FC²₁, FC²₂ . . . FC²ᵢ . . . FC²_{N}} is a second set of empirical, temperature-independent fitting coefficients.

Although the use of glass transition temperature and fragility are preferred approaches for developing expressions for f₁(x,FC1) and f₂(x,FC2) in the above expressions, other approaches can be used, if desired. For example, the strain point or the softening point of the glass, together with the slope of the viscosity curves at these temperatures can be used.

As can be seen from Eqs. (6), (7), (8), (13), and (14), the computer-implemented model disclosed herein for predicting/estimating non-equilibrium viscosity can be based entirely on changes in glass transition temperature T_{g}(x) and fragility m(x) with composition x, which is an important advantage of the technique. As discussed above, T_{g}(x) and m(x) can be calculated using temperature dependent constraint theory and a superposition of heat capacity curves, respectively, in combination with empirically-determined fitting coefficients. Alternatively, T_{g}(x) and m(x) can be determined experimentally for any particular glass of interest.

In addition to their dependence on T_{g}(x) and m(x), Eqs. (6), (7), (8), and (13) also depend on the glass's fictive temperature T_{f}. In accordance with the present disclosure, the calculation of the fictive temperature associated with the thermal history and glass properties of a particular glass composition can follow established methods, except for use of the non-equilibrium viscosity model disclosed herein to set the time scale associated with the evolving T_{f}. A non-limiting, exemplary procedure that can be used is as follows.

In overview, the procedure uses an approach of the type known as “Narayanaswamy's model” (see, for example, Relaxation in Glass and Composites by George Scherer (Krieger, Fla., 1992), chapter 10), except that the above expressions for non-equilibrium viscosity are used instead of Narayanaswamy's expressions (see Eq. (10.10) or Eq. (10.32) of Scherer).

A central feature of Narayanaswamy's model is the “relaxation function” which describes the time-dependent relaxation of a property from an initial value to a final, equilibrium value. The relaxation function M(t) is scaled to start at 1 and reach 0 at very long times. A typical function used for this purpose is a stretched exponential, e.g.:

$$M ( t ) = exp ( - {( \frac{t}{τ} )}^{b} ) \qquad ( 15 )$$

Other choices are possible, including:

$${M}_{s} = {\sum }_{i = 1}^{N} {w}_{i} exp ( - {α}_{i} \frac{t}{τ} ) \qquad ( 16 )$$

where the αᵢ are rates that represent processes from slow to fast and the wᵢ are weights that satisfy:

$${\sum }_{i = 1}^{N} {w}_{i} = 1 \qquad ( 17 )$$

The two relaxation function expressions of Eqs. (15) and (16) can be related by choosing the weights and rates to make M, most closely approximate M, a process known as a Prony series approximation. This approach greatly reduces the number of fitting parameters because arbitrarily many weights and rates N can be used but all are determined by the single stretched exponential constant b. The single stretched exponential constant b is fit to experimental data. It is greater than 0 and less than or equal to 1, where the value of 1 would cause the relaxation to revert back to single-exponential relaxation. Experimentally, the b value is found most often to lie in the range of about 0.4 to 0.7.

In Eqs. (15) and (16), t is time and τ is a time scale for relaxation also known as the relaxation time. Relaxation time is strongly temperature dependent and is taken from a “Maxwell relation” of the form:

τ(T,T_{f})=η(T,T_{f})/G(T,T_{f}) (18)

In this expression, G(T,T_{f}) is a shear modulus although it need not be a measured shear modulus. In an embodiment, G(T,T_{f}) is taken as a fitting parameter that is physically approximately equal to a measured shear modulus. η is the non-equilibrium viscosity of Eq. (6), which depends on both T and T_{f}.

When relaxation proceeds during a time interval over which the temperature is changing, then the time dependence of both the temperature and the fictive temperature need to be taken into account when solving for time-varying fictive temperature. Because fictive temperature is involved in setting the rate of its own time dependence through Eq. (18), it shows up on both sides of the equation as shown below. Consistent with Eq. (16), it turns out that the overall fictive temperature T_{f} can be represented as a weighted sum of “fictive temperature components” or modes in the form

$${T}_{f} = {\sum }_{i = 1}^{N} {w}_{i} {T}_{fi} \qquad ( 19 )$$

using the same weights as before, i.e., the same weights as in Eqs. (11) and (12). When this is done, the time evolution of fictive temperature satisfies a set of coupled differential equations, where each of T_{f}, T_{fi}, and T are a function of time:

$$\frac{d {T}_{fi}}{d t} = \frac{{α}_{i}}{τ ( T , {T}_{f} )} ( T - {T}_{fi} ) = \frac{G ( T , {T}_{f} ) {α}_{i}}{η ( T , {T}_{f} )} ( T - {T}_{fi} ) , \\ i = 1 … N . \qquad ( 20 )$$

Note that the time evolution of fictive temperature components depends on the present value of the overall fictive temperature T_{f} through the role of setting the time scale of relaxation through the viscosity. In this approach, it is only the viscosity that couples together the behavior of all the fictive temperature components. Recalling that the rates αᵢ and the weights wᵢ are fixed by the single value of the stretching exponent b, they and G(T,T_{f}) can be taken to be time-independent, although other choices are possible. When numerically solving the set of N equations of Eq. (20), the techniques used need to take into account both the fact that individual equations can have wildly different time scales and the manner in which T_{f} occurs on the right hand side inside the viscosity.

Once the fictive temperature components are known at any given time through Eq. (20), the fictive temperature itself is calculated using Eq. (19). In order to solve Eq. (20) by stepping forward in time it is necessary to have initial values for all the fictive temperature components. This can be done either by knowing their values based on previous calculations or else by knowing that all the fictive temperature components are equal to the current temperature at an instant of time.

Eventually all calculations must have started in this way at some earlier time, i.e., at some point in time, the glass material must be at equilibrium at which point all the fictive temperature components are equal to the temperature. Thus, all calculations must be traceable back to having started in equilibrium.

It should be noted that within this embodiment, all knowledge of the thermal history of the glass is encoded in the values of the fictive temperature components (for a given set of the weights and so forth that are not time-dependent). Two samples of the same glass that share identically the same fictive temperature components (again, assuming all other fixed model parameters are the same) have mathematically identical thermal histories. This is not the case for two samples that have the same overall T_{f}, as that T_{f} can be the result of many different weighted sums of different T_{fi}'s.

The mathematical procedures described above can be readily implemented using a variety of computer equipment and a variety of programming languages or mathematical computation packages such as MATHEMATICA (Wolfram Research, Champaign, Ill.), MATLAB (MathWorks of Natick, Mass.), or the like. Customized software can also be used. Output from the procedures can be in electronic and/or hard copy form, and can be displayed in a variety of formats, including in tabular and graphical form. For example, graphs of the types shown in the figures can be prepared using commercially available data presentation software such as MICROSOFT's EXCEL program or similar programs. Software embodiments of the procedures described herein can be stored and/or distributed in a variety of forms, e.g., on a hard drive, diskette, CD, flash drive, etc. The software can operate on various computing platforms, including personal computers, workstations, mainframes, etc.

FIG. 3 is a graph showing the temperature change of the glass as the glass ribbon is moved away from a root (i.e., a root point of the glass ribbon) in the glass making process. The solid line shows the temperature change where the cooling rate is slowed during at least a part of the glass state in which the glass is not in thermal equilibrium (i.e., slowed cooling stage). Meanwhile, the dotted line shows the temperature change where no attempt of slowing the cooling rate is made. An initial temperature T₀ may refer to the temperature corresponding to the viscosity at a root of the glass ribbon. An exit temperature T₃ may refer to the temperature corresponding to the viscosity at an exit point, i.e., the end of the glass ribbon and is generally not higher than 600° C. such that the stability of the glass ribbon can be maintained. The slowed cooling stage may occur between a process start temperature T₁ and a process end temperature T₂, and the glass ribbon may be subjected to cooling that is substantially slower than cooling before process start temperature T₁ is reached or after process end temperature T₂ is reached. While it may be difficult to maintain a constant cooling rate between two temperatures, it is possible to alter the cooling rates in a temperature range such that an average cooling rate in this temperature range is significantly slower or faster than outside this temperature range.

Slowing down the cooling rate at a temperature where the glass rapidly equilibrates with its actual temperature brings no benefit in reduction of the fictive temperature. This is because the glass remains in thermodynamic equilibrium with the actual temperature even at the faster cooling rate, so no additional equilibration is possible. Thus, the slowed cooling is configured to begin at a process start temperature T₁ above which the glass maintains the thermal equilibrium state and below which the glass falls out of equilibrium. The process start temperature T₁ may be a temperature corresponding to viscosity value between 10¹⁰ and 10¹³ poise. 10¹³ poise corresponds with the glass transition temperature, which is the lowest recommended temperature at which the slowed cooling should be initiated, while 10¹⁰ poise corresponds with higher temperatures that are a little above the glass transition temperature T_{g}. Because the falling out of equilibrium or the equivalent lagging of the fictive temperature is a continuous process and does not have a sharply defined start and stop, the slowed cooling is not started exactly at 10¹³ poise but rather somewhere in the indicated range. The process end temperature T₂ below which the cooling rate is no longer slowed is chosen as a compromise between practical considerations, such as fusion draw height, glass speed down the draw, process time or other considerations, and the desire to keep a slow cooling rate until the rate of relaxation is so slow that further reduction in the cooling rate has a negligible effect on relaxation. This will be chosen to be sufficiently low while being consistent with the cooling achievable at the higher temperatures and also the practical considerations mentioned above. For example, the process end temperature T₂ may be a temperature slightly higher than the exit temperature T₃. The exit temperature T₃ is taken to represent a temperature at which the glass is removed from the process, all deliberate cooling having effectively ceased. Some remaining cooling to ambient room temperature may still occur but this cooling is not intended to be controlled. Between T₂ and T₃ the glass may be cooled more rapidly without causing any further departure from equilibrium because in this temperature range the relaxation rate is extraordinarily slower than between T₁ and T₂, rendering the impact of cooling rate on relaxation negligible.

It should be noted that, while the x-axis in the graph of FIG. 3 indicates the distance from the root point of the glass ribbon, a similar graph can be obtained where the x-axis indicates the time elapsed after a certain point on the glass ribbon leaves the root point.

TABLE 1
The factors included in the slowed cooling

| Factors | Values selected |
|---|---|
| T₁/t₁(° C./h) | 715/0.0027778, 699/0.00294631, 684/0.003752, |
| | 666/0.003561, 648/0.003327, 634/0.003125 |
| T₃ (° C.) | 648, 634, 619, 606, 592, 580, 560, 540, 520, 500 |
| t₃ (hr) | 0.00925, 0.04625, 0.185 |
| log(η_{T1}) (poise) | 10.2, 10.6, 11, 11.5, 12, 12.5 |
| log(η_{T3}) (poise) | 12, 12.5, 13, 13.5, 14, 14.5, 15.4, 16.3, 17.4, 18.6 |

TABLE 2
The fictive temperature calculation based on the values from Table 1

| log(η_{T1}) | log(η_{T3}) | T_{ƒ}(° C.) | | |
|---|---|---|---|---|
| (poise) | (poise) | t₃ = 0.00925 h | t₃ = 0.04625 h | t₃ = 0.185 h |
| 10.2 | 14 | 666.9 | — | — |
| | 13.5 | 666.4 | — | — |
| | 13 | 666.6 | — | — |
| | 12.5 | 667.4 | — | — |
| 10.6 | 14.5 | — | 644.9 | — |
| | 14 | 666.5 | 644.8 | — |
| | 13.5 | 666.1 | 645.2 | — |
| | 13 | 666.1 | 646.3 | — |
| | 12.5 | 666.7 | 649.1 | — |
| 11 | 18.6 | 672.9 | 649.2 | 630.6 |
| | 17.4 | 671.9 | 648 | 629.6 |
| | 16.3 | 670.8 | 646.8 | 628.7 |
| | 15.4 | 669.6 | 645.6 | 628 |
| | 14.5 | 668.2 | 644.7 | 627.9 |
| | 14 | 667.7 | 644.3 | 628.4 |
| | 13.5 | 667 | 644.3 | 630 |
| | 13 | 666.5 | 645.2 | 633.2 |
| | 12.5 | 666.2 | 647.8 | 639.9 |
| | 12 | 666.7 | — | — |
| 11.5 | 18.6 | 673.9 | 651.8 | 631.9 |
| | 17.4 | 673 | 650.5 | 630.6 |
| | 16.3 | 672 | 649.2 | 629.3 |
| | 15.4 | 670.9 | 647.8 | 628.1 |
| | 14.5 | 669.5 | 646.5 | 627.49 |
| | 14 | 669.1 | 645.9 | 627.53 |
| | 13.5 | 668.3 | 645.5 | 628.8 |
| | 13 | 667.7 | 645.9 | 631.7 |
| | 12.5 | 667.3 | 647.7 | 638 |
| | 12 | 667.6 | — | — |
| log(η_{T1}) | log(η_{T3}) | | | |
| (poise) | (poise) | T_{ƒ}(° C.) | | |
| 12 | 18.6 | 675.1 | 655.3 | 636.2 |
| | 17.4 | 674.2 | 654.1 | 634.7 |
| | 16.3 | 673.3 | 652.9 | 633.1 |
| | 15.4 | 672.3 | 651.4 | 631.5 |
| | 14.5 | 671.3 | 650 | 630.1 |
| | 14 | 670.6 | 649.3 | 629.7 |
| | 13.5 | 669.9 | 648.7 | 630.1 |
| | 13 | 669.3 | 648.6 | 632.1 |
| | 12.5 | 668.9 | 649.7 | 637.5 |
| | 12 | 669.0 | — | — |
| 12.5 | 18.6 | 675.8 | 657.9 | 640.3 |
| | 17.4 | 675.1 | 656.8 | 638.8 |
| | 16.3 | 674.2 | 655.6 | 637.2 |
| | 15.4 | 673.3 | 654.3 | 635.5 |
| | 14.5 | 672.4 | 653 | 633.9 |
| | 14 | 671.8 | 652.2 | 633.3 |
| | 13.5 | 671.1 | 651.6 | 633.2 |
| | 13 | 670.6 | 651.3 | 634.3 |
| | 12.5 | 670.1 | 652 | 638.5 |

Table 1 shows examples of the process start temperatures T₁ with corresponding process start times t₁, the exit temperatures T₃, process durations t₃ (which is equal to the exit times at which the exit point is reached), logarithms of process start viscosities η_{T1} corresponding to the process start temperatures η_{T1}, logarithms of exit viscosities η_{T3} corresponding to the exit temperatures T₃. Table 2 shows example combinations of the process start viscosities log(η_{T1}) matched with selected number of exit viscosities log(η_{T3}) and the final fictive temperatures T_{f} reached at the exit times t₃ for each combination. It should be understood that a combination is possible only if the process start temperature T₁ is higher than the exit temperature T₃ (or if the process start viscosity η_{T1} is lower than the exit viscosity η_{T3}). Also, it must be noted that the difference between the process end time t₂ and the exit time t₃ is sufficiently small as to be insignificant as it relates to the fictive temperature T_{f} in most cases. In at least a part of the temperature ranges (or predetermined viscosity ranges) of Table 2, the fictive temperature of the glass ribbon lags the actual temperature of the glass ribbon.

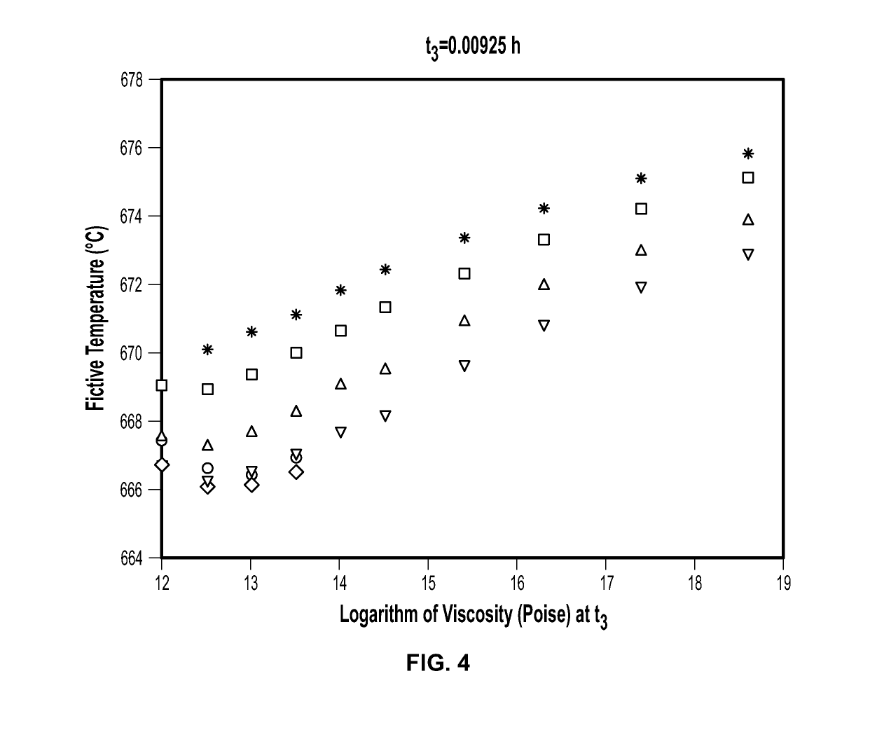

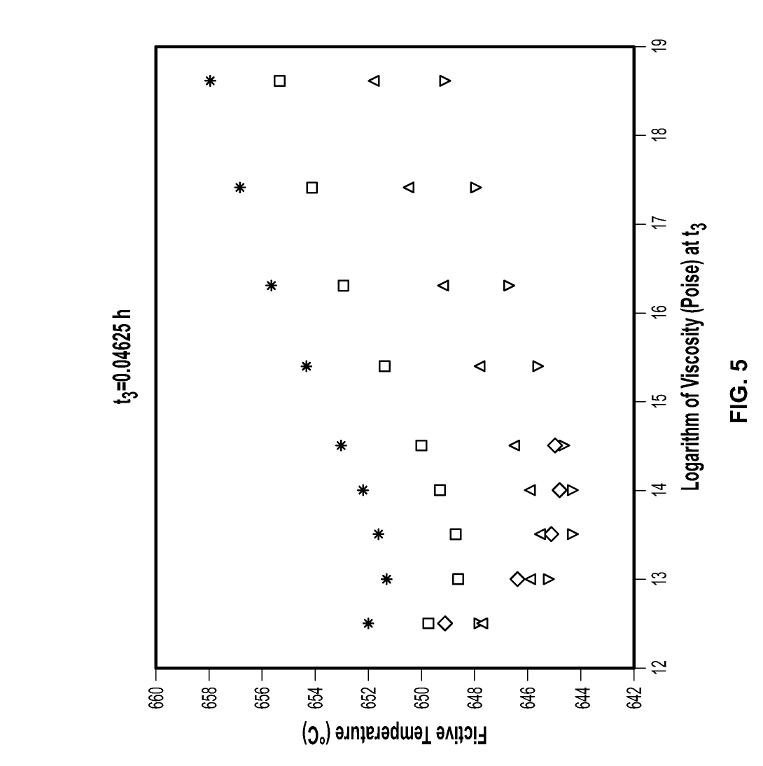

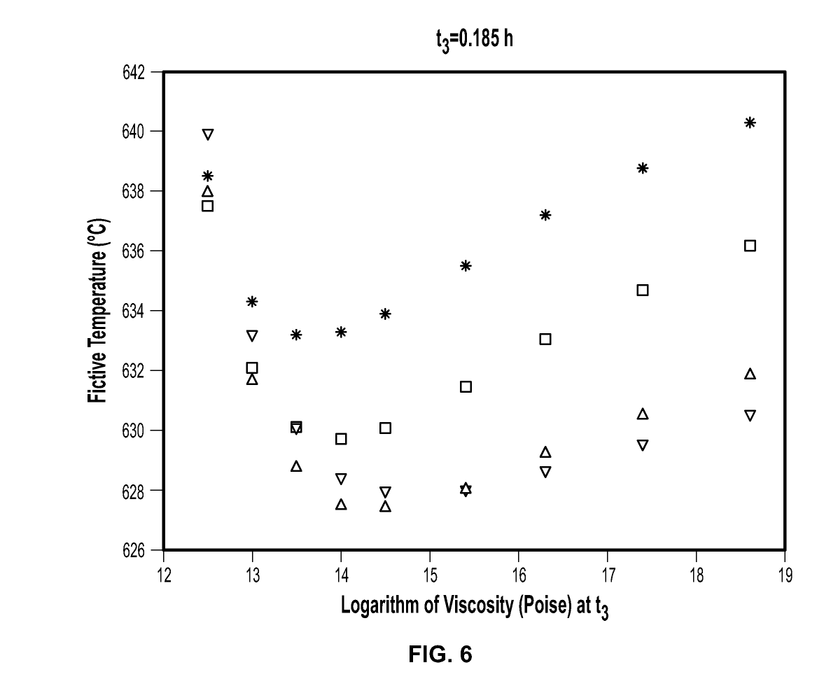

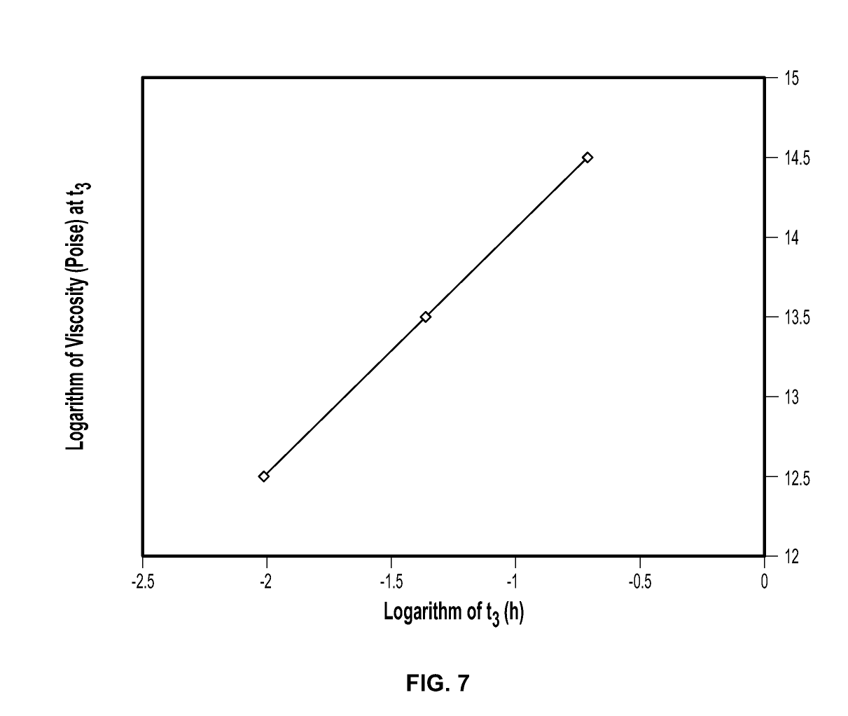

The results from Table 2 are illustrated in the graphs of FIGS. 4-6. Experimental data such as those in Tables 1 and 2 indicate the varying degrees by which the fictive temperature T_{f} can be lowered within a temperature range over a given process duration t₃. FIGS. 4-6 are plots of the fictive temperature T_{f} as versus the logarithms of the exit viscosity log(η_{T3}) differentiated by logarithms of the process start viscosities log(η_{T1}) for different process durations t₃. Throughout FIGS. 4-6, the asterisks denote data for the logarithms of the process start viscosities log(η_{T1}) having a value of 12.5, the squares denote data for the logarithms of process start viscosities log(η_{T1}) having a value of 12, the upwardly pointing triangles denote data for the logarithms of the process start viscosities log(η_{T1}) of 11.5, the downwardly pointing triangles denote data for the logarithms of the process start viscosities log(η_{T1}) of 11, the diamonds denote data for the logarithms of the process start viscosities log(η_{T1}) having a value of 10.6, and the circles denote data for the logarithms of the process start viscosities log(η_{T1}) having a value of 10.2. With regard to the process duration t₃ of 0.00925 hours in FIG. 4, low fictive temperatures were reached by increasing the logarithms of the viscosity (and their corresponding temperatures) from 11 to 12.5 or from 10.6 to 13 or 13.5. With regard to the process duration t₃ of 0.0425 hours in FIG. 5, the low fictive temperatures were reached by increasing the logarithms of the viscosity from 11 to 13.5 or 14. With regard to the process duration t₃ of 0.185 hours in FIG. 6, the low fictive temperatures were reached by increasing the logarithms of the viscosity from 11.5 to 14 or 14.5. In one example combination of slowed cooling, the fictive temperature was lowered by 37 degrees and resulted in an improvement of 90 MPa in compressive stress after ion exchange. Moreover, an overall trend was that, for a given combination of the process start temperature T₁ and the exit temperature T₃ (which is close to the process end temperature T₂), a lower fictive temperature was reached when the process duration t₃ was longer. The process duration t₃ is primarily lengthened by increasing the time for the glass ribbon to cool from the process start temperature T₁ to the process end temperature T₂. Furthermore, as shown in FIG. 7, which shows a linear fit obtained from a plot of the logarithms of the exit viscosity log(η_{T3}) versus the logarithms of exit times or process durations t₃, it was observed that the logarithm of the exit viscosity η_{T3} is linearly related to the logarithm of the exit time or process duration t₃ which is in agreement with Eq. (2). The agreement with Eq. (2) is obtained in the following way. Consider that the constant cooling rate Q_{c} of Eq. (2) implies the relation ΔT=Q_{c}·t₃ where ΔT is the temperature difference from t=0 to t=t₃ during the constant cooling. This also gives Q_{c}=ΔT/t₃ from which we get log(Q_{c})=log(ΔT)−log(t₃). Equation (2) can therefore be rewritten in terms of t₃ instead of in terms of Q_{c} in the form Δ log η=−Δ(log Q_{c})=Δ(log t₃)−Δ(log ΔT). The last term in this equation is just a constant, so this establishes a linear relation between changes in the logarithm of viscosity and changes in the logarithm of t₃. This is mentioned because it helps establish the internal consistency of the relations used to define slowed cooling.

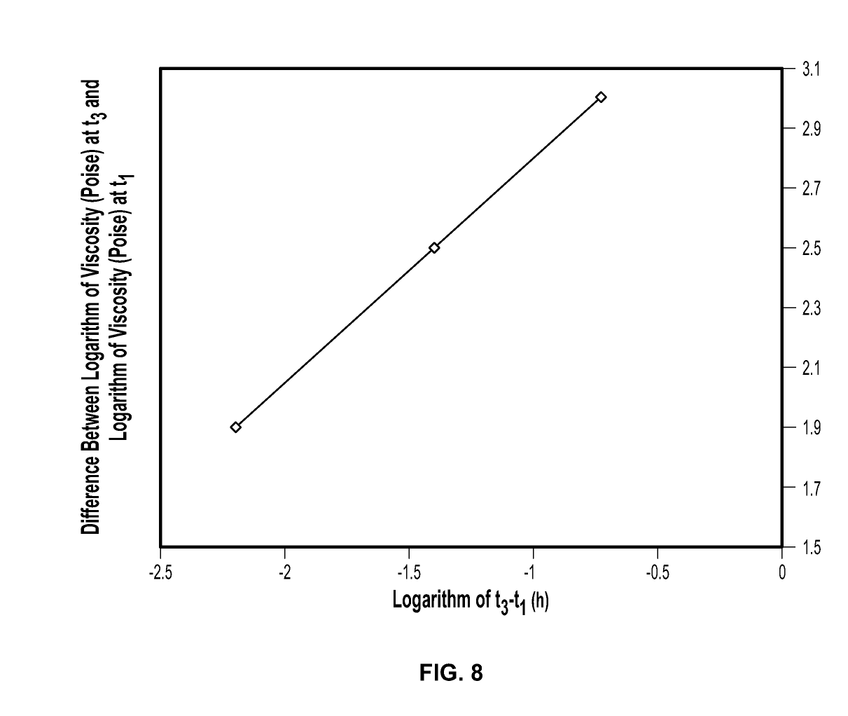

Also, as shown in FIG. 8, which shows a linear fit obtained from a plot of the difference between the logarithm of the exit viscosity log(η_{T3}) and the logarithms of the process start viscosity log(η_{T1}) versus the logarithms of t₃−t₁, the difference between the logarithm of the viscosity at the end of the slowed cooling and the logarithm of the viscosity at the start of the slowed cooling was almost linearly related to the logarithm of the slowed cooling duration (t₃−t₁). The basis for this agreement is the same relation described in the previous paragraph only applied to a different interval of the cooling. Note that the linearity of FIG. 7 and FIG. 8 is only approximate, as the real cooling curve is not fully described by a single constant cooling rate such as Q_{c}, but this shows that the simplified relations based on Eq. (1) and Eq. (2) still hold rather well for a more realistic cooling curve.

FIG. 9 is a schematic illustration of a plurality of heating elements 116 that may be located near the pull roll assembly 112 and that control the temperature of the glass ribbon 136. A plurality of pulling rolls 138 located along the glass ribbon 136 help guide and/or move the glass ribbon 136 as the glass flows down from the forming vessel 110. The heating elements 116 extend from the root point 136a to the exit point 136b of the drawn glass ribbon 136 and generate heat H that is transferred to the glass ribbon 136. The heating elements 116 are configured to generate heat that is transferred to the glass ribbon 136 and may be embodied, for example, as a coil assembly so that the amount of electricity and thus heat generated therefrom can be controlled. The glass ribbon 136 at the root 134 is generally at a much higher temperature than neighboring components and cools while moving through an enclosed space 140 which may be defined by a chamber with insulating walls 142.

The neighboring components may be provided to control the cooling rate from the root point 136a to the exit point 136b. The heating elements 116 may be arranged such that the heating elements 116 along one zone the glass ribbon 136 moves through are controlled independently from the heating elements 116 along another zone that the glass ribbon 136 moves through. For example, in FIG. 9, the heating elements 116b may be controlled independent from the heating elements 116a or 116c. Furthermore, the insulating wall 142 may be formed such that the degree of heat insulation along one zone the glass ribbon 136 moves through is different from the degree of heat insulation along another zone the glass ribbon 136 moves through. In one example, the insulating wall 142a and the insulating wall 142b may have the same thickness but may be made of different materials such that the levels of thermal conductivity are different in the respective zones. In another example, the insulating wall 142b and the insulating wall 142c may be made of the same material but may be have different thicknesses such that the degrees of thermal insulation are different in the respective zones.

Slowed cooling may be conducted in zone 144 and there are a number of ways of slowing down the cooling rate between the process start temperature T₁ and the process end temperature T₂ through the zone 144. In a first example, the cooling rate can be slowed by increasing the power of heating elements 116b located in the zone 144. In a second example, the cooling rate can be slowed by increasing the height of the draw such that the distance over which the heating elements 116b extend next to the glass ribbon 136 is increased and such that heating is provided over a longer zone 144 while keeping other variables constant. In a third example, the degree of thermal insulation can be made higher in the zone 144 as discussed above either by lowering the thermal conductivity of the insulating wall 142b or increasing the thickness of the insulating wall 142b. In a fourth example, the glass ribbon 136 may be moved at a relatively slower speed so that the glass ribbon 136 spends more time in the zone 144. In a fifth example, the glass ribbon 136 may be more actively cooled in zones 146 and 148, for example, by using blowers to cool the glass ribbon 136 rather than allowing still air in the enclosed space 140 to cool the glass ribbon 136. It may also be possible to do without the heating elements 116a and 116c in the zones 146 and 148 respectively to achieve relatively slow cooling in the zone 144.

It will be apparent to those skilled in the art that various modifications and variations can be made without departing from the spirit and scope of the claimed invention.

What is claimed is:

1. A method of making glass through a glass ribbon forming process in which a glass ribbon is drawn from a root point to an exit point, the method comprising the steps of:
decreasing a temperature of the glass ribbon from an initial temperature to a process start temperature, the initial temperature corresponding to a temperature at the root point;
decreasing a temperature of the glass ribbon from the process start temperature to a process end temperature;
decreasing a temperature of the glass ribbon from the process end temperature to an exit temperature, the exit temperature corresponding to a temperature at the exit point; and
wherein a fictive temperature of the glass ribbon lags an actual temperature of the glass ribbon in step (II), and a duration of step (II) is substantially longer than a duration of step (I) and a duration of step (III).

2. The method of claim 1, further comprising the step of conducting an ion-exchange process on the glass after steps (I), (II) and (III).

3. The method of claim 1, wherein the glass ribbon is moved over a substantially greater distance during step (II) than during step (I) or step (III).

4. The method of claim 1, wherein the exit temperature is not higher than 600° C.

5. The method of claim 1, wherein the process start temperature corresponds to a viscosity between 10¹⁰ poise and 10¹³ poise.

6. The method of claim 1, wherein step (II) involves increasing a distance from the root point to the exit point.

7. The method of claim 1, wherein the glass ribbon forming process is a fusion draw process.

8. The method of claim 1, wherein the glass ribbon comprises an ion-exchangeable glass.

9. A method of making glass through a glass ribbon forming process, in which a glass ribbon is drawn from a root point to an exit point, the method comprising the steps of:
(I) cooling the glass ribbon at a first cooling rate from an initial temperature to a process start temperature, the initial temperature corresponding to a temperature at the root point;
(II) cooling the glass ribbon at a second cooling rate from the process start temperature to a process end temperature;
(III) cooling the glass ribbon at a third cooling rate from the process end temperature to an exit temperature, the exit temperature corresponding to a temperature at the exit point; and
wherein an average of the second cooling rate is lower than an average of the first cooling rate and an average of the third cooling rate.

10. The method of claim 8, further comprising the step of conducting an ion-exchange process on the glass after steps (I), (II) and (III).

11. The method of claim 8, wherein a fictive temperature of the glass ribbon lags an actual temperature of the glass ribbon in step (II).

12. The method of claim 8, wherein the glass ribbon is moved over a substantially greater distance during step (II) than during step (I) or step (III).

13. The method of claim 8, wherein the exit temperature is not higher than 600° C.

14. The method of claim 8, wherein the process start temperature corresponds to a viscosity between 10¹⁰ poise and 10¹³ poise.

15. The method of claim 8, wherein step (II) involves increasing a distance from the root point to the exit point.

16. The method of claim 8, wherein the first cooling rate is substantially larger than the second cooling rate.

17. The method of claim 8, wherein the glass ribbon forming process is a fusion draw process.

18. The method of claim 9, wherein the glass of the glass ribbon is an ion-exchangeable glass.
